(19) United States
(12) Patent Application Publication
(10) Pub. No.: US 2024/0248767 A1
(43) Pub. Date: Jul. 25, 2024

(54) RESOURCE SHARING

(71) Applicant: INTERNATIONAL BUSINESS MACHINES CORPORATION, ARMONK, NY (US)

(72) Inventors: Ting Liang, Beijing (CN); Zhi Gang Sun, Beijing (CN); Xin Peng Liu, Beijing (CN); Chun Li Jia, Beijing (CN)

(21) Appl. No.: 18/158,622

(22) Filed: Jan. 24, 2023

(51) Int. Cl. G06F 9/50; G06F 9/54

(52) U.S. Cl. CPC G06F 9/505; G06F 9/541

(57) ABSTRACT

Disclosed are techniques for resource sharing. Resource sharing information comprising resource metadata for a shared resource of a sharer can be stored by one or more processing units. A virtual link can be generated by one or more processing units based on the resource metadata. The virtual link can be transmitted to one or more sharees by one or more processing units based on the resource metadata. The resource metadata can be updated by one or more processing units.

### BACKGROUND

The present disclosure relates to resource sharing, and more specifically, to a computer-implemented method, a system, and a computer program product for resource sharing.

In daily work, people often manipulate various kinds of resources. The resources can be of any form of objects, such as web pages, online documents, etc. Resource sharing is a widely used method for collaboration purposes. Resources can be shared in multiple ways, such as replication, Uniform Resource Locator (URL), etc.

There are some challenges in the ways in which a resource is shared. For example, there is no efficient sharing access management, and there is no efficient way to re-activate sharing as needed when the resource sharing becomes invalid. Currently, if a sharing becomes invalid, (e.g., a URL through which a sharee can access a resource is expired) the sharee must contact a sharer to request re-granting of access to the resource, and the sharer accordingly has to generate a new URL for the sharee to access the same resource. As a result, it can be time-consuming or impossible for a sharee to access a resource once it becomes invalid.

US20160269471A1 discloses a method for providing one-to-one (peer-to-peer) “information exchange over a web based environment” (US20160269471A1, [0006]), where “users can post or un-post messages, files, folders, or other resources information on the systems of the CCDSVM, with group based-model or non-group 1-to-1 model to one or more audiences (other users) on the network” (US20160269471A1, [0008]). However, US20160269471A1 does not disclose how to re-activate sharing when the resource sharing becomes invalid.

US20180121465A1 discloses a “group file list cache is maintained for each of a plurality of different groups. [ . . . ] The list of files corresponding to each group is merged into a single, aggregate list and is surfaced for user interaction” (US20180121465A1, [0005]). However, US20180121465A1 does not disclose how to re-activate sharing when the resource sharing becomes invalid.

### SUMMARY

Therefore, there is a need to provide a way to manage the resource sharing and re-activate sharing when the resource sharing becomes invalid. The present disclosure provides a computer-implemented method, a system, and a computer program product for resource sharing to solve at least one of the above problems.

According to some embodiments of the present disclosure, there is provided a computer-implemented method for resource sharing. In this method, resource sharing information comprising resource metadata for a shared resource of a sharer can be stored by one or more processing units. A virtual link can be generated by one or more processing units based on the resource metadata. The virtual link can be transmitted to one or more sharees by one or more processing units based on the resource metadata. The resource metadata can be updated by one or more processing units. This embodiment can enable the one or more sharees to access the shared resource seamlessly during a whole sharing lifecycle of the shared resource without being interrupted by having to contact a sharer.

In an optional embodiment of the computer-implemented method for resource sharing, the resource metadata can be updated by one or more processing units periodically. Alternatively, the resource metadata can be updated by one or more processing units based on updated resource metadata being received from the sharer. In this embodiment, in case the resource metadata is expired, a proper re-mapping between the virtual link and the updated resource metadata can be established through the updating, and thus the one or more sharees can successfully access the shared resource via the same virtual link without having to manually contact the sharer even if the resource metadata has changed.

In an optional embodiment of the computer-implemented method for resource sharing, a resource request for the shared resource related with the virtual link can be received by one or more processing units. Based on the resource metadata being expired, an activation request can be sent to the sharer for re-activating the shared resource through one or more channels. The resource metadata can be updated by one or more processing units based on the re-activating of the shared resource by the sharer. In this embodiment, updating of the resource metadata can be performed after receiving the resource request, which brings less workload to both the sharer and the control unit.

In an optional embodiment of the computer-implemented method for resource sharing, the resource sharing information can further comprise a delegation policy. A resource request for the shared resource related with the virtual link can be received by one or more processing units. Based on the delegation policy indicating full delegation and the resource metadata being expired, the resource metadata can be updated by one or more processing units according to a re-activation policy. In this embodiment, updating of the resource metadata can be performed after receiving the resource request, which brings less workload to both the sharer and the control unit. Furthermore, updating of the resource metadata can be performed automatically based on predefined re-activation policy by the sharer, thereby avoiding interrupting the sharer.

In an optional embodiment of the computer-implemented method for resource sharing, the resource metadata can further comprise a termination policy. The resource sharing information for a sharee among the one or more sharees can be removed by one or more processing units based on sharing of the shared resource for the sharee being terminated according to the termination policy. In this embodiment, sharing of the resource can be terminated automatically.

According to another embodiment of the present disclosure, there is provided a system for resource sharing. The system can comprise one or more processors, a computer-readable medium coupled to at least one of the processors and a set of computer program instructions stored in the computer-readable medium. When executed by at least one of the processors, the set of computer program instructions perform the following actions. Resource sharing information comprising resource metadata for a shared resource of a sharer can be stored. A virtual link can be generated based on the resource metadata. The virtual link can be transmitted to one or more sharees based on the resource metadata. The resource metadata can be updated. This embodiment can enable the one or more sharees to access the shared resource seamlessly during a whole sharing lifecycle of the shared resource without being interrupted by having to contact a sharer.

According to another embodiment of the present disclosure, a computer program product for resource sharing is disclosed. The computer program product comprises one or more computer-readable storage media having program instructions collectively embodied therewith, and the program instructions are executable by one or more processors. When executed, the program instructions cause the one or more processors to perform one or more of the above described procedures. This embodiment can enable the one or more sharees to access the shared resource seamlessly during a whole sharing lifecycle of the shared resource without being interrupted by having to contact a sharer.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computing environment which is applicable to implement the embodiments of the present disclosure.

FIG. 2 shows a schematic diagram of a scenario to which some embodiments of the present disclosure are applied.

FIG. 3 shows a flowchart of an example method for resource sharing according to some embodiments of the present disclosure.

FIG. 4 shows example sub-operations of an operation in the method of FIG. 3 according to some embodiments of the present disclosure.

FIG. 5 shows a flowchart of another example method for resource sharing according to some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as resource sharing code 200. In addition to resource sharing code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and resource sharing code 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

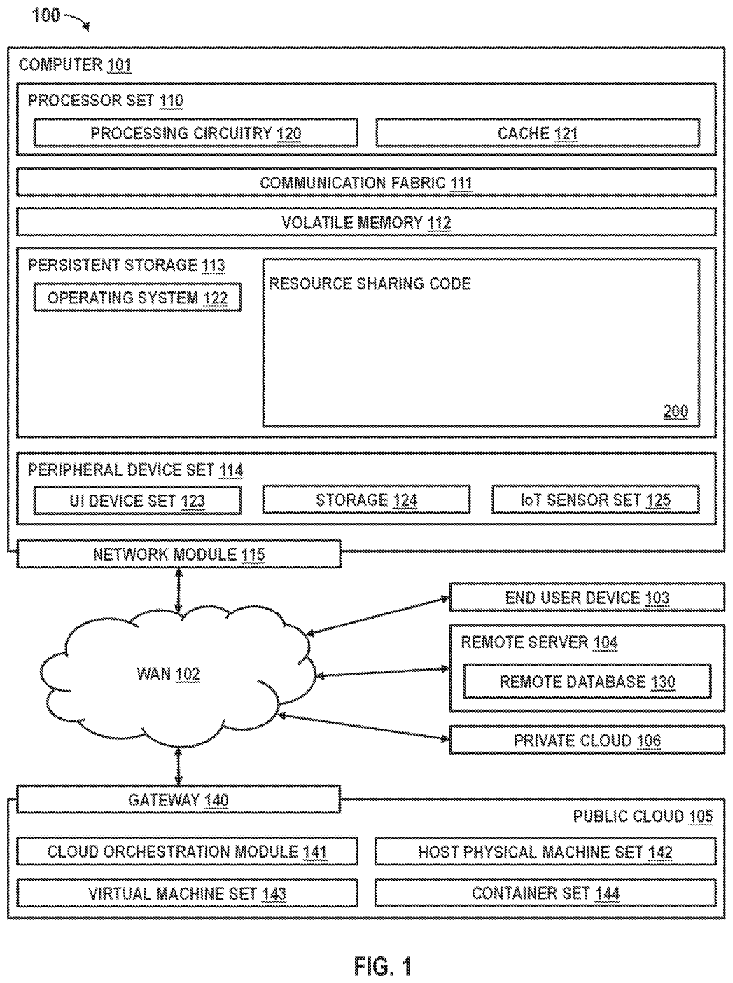

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in resource sharing code 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in resource sharing code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is understood that the computing environment 100 in FIG. 1 is only provided for illustration purpose without suggesting any limitation to any embodiment of this disclosure, for example, at least part of the program code involved in performing the inventive methods could be loaded in cache 121, volatile memory 112 or stored in other storage (e.g., storage 124) of the computer 101, or at least part of the program code involved in performing the inventive methods could be stored in other local or/and remote computing environment and be loaded when need. For another example, the peripheral device set 114 could also be implemented by an independent peripheral device connected to the computer 101 through interface. For a further example, the WAN may be replaced and/or supplemented by any other connection made to an external computer (for example, through the Internet using an Internet Service Provider).

Embodiments of the present disclosure aim to solve at least one of the technical problems described above, and propose a method, a system, and computer program product for resource sharing, enabling control over access to a shared resource, and enabling one or more sharees to access a shared resource seamlessly during a whole sharing lifecycle of the shared resource without being interrupted by having to contact a sharer.

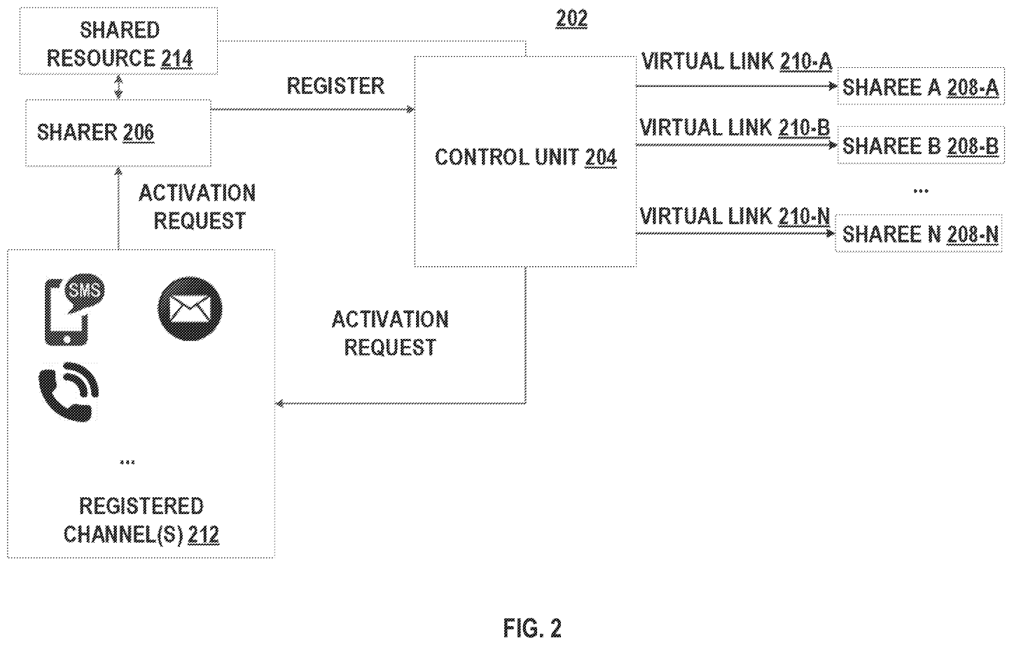

Referring now to FIG. 2, shown is a schematic diagram of a scenario 202 to which some embodiments of the present disclosure can be applied. As can be seen in FIG. 2, some embodiments of the present disclosure introduce a control unit 204 between a sharer 206 and one or more sharees 208 (including sharee A 208-A, sharee B 208-B, and sharee N 208-N, where N can be any positive integer) to solve at least one of the technical problems described above. The control unit 204 can be used to control the entire sharing process and optionally be able to communicate with the sharer 206 for more efficient sharing. The sharer 206 can register resource metadata of a shared resource 214, which may be necessary for generating a virtual link 210 (e.g., 210-A, 210-B, and 210-N, where each virtual link 210 can correspond to at least one sharee 208) to the control unit 204 for one or more sharees 208 to access the shared resource 214. The sharer 206 can also register one or more channels 212 which can be used for the control unit 204 to communicate with the sharer 206. The control unit 204 can generate a virtual link 210 for the one or more sharees 208 to access the shared resource 214. The control unit 204 can also communicate with the sharer 206 by sending an activation request through the registered one or more channels 212 when access to the shared resource 214 with the registered resource metadata fails. Therefore, the control unit 204 can automatically request the sharer 206 to re-activate the shared resource 214. From the perspective of the one or more sharees 208, it is possible to always use the same virtual link 210 easily and successfully to access the shared resource 214 without manually contacting the sharer 206 before the sharing is terminated, even if the resource metadata such as the storage address of the shared resource 214 changes. The control unit 204 can be implemented, for example, in one or more elements of the computing environment of FIG. 1.

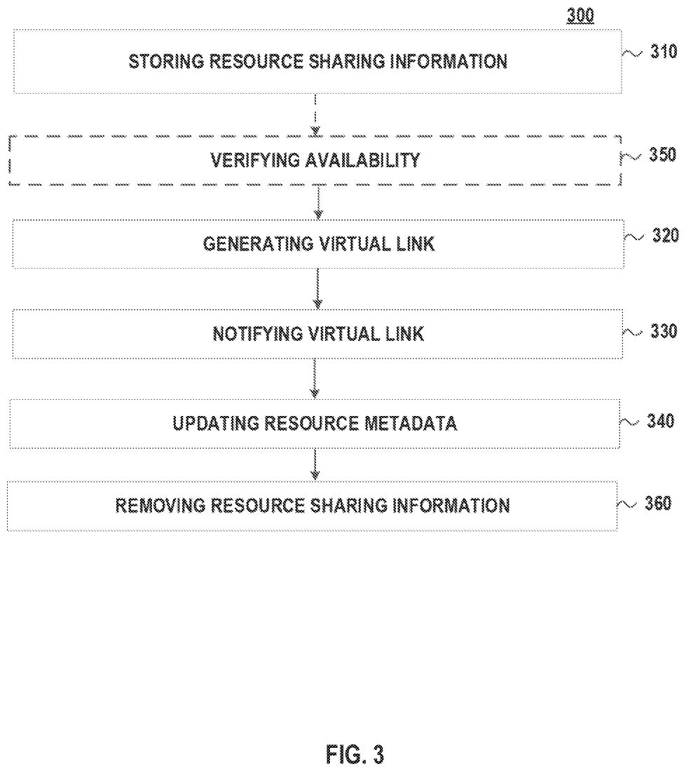

With reference now to FIG. 3, shown a flowchart of a method 300 for resource sharing according to some embodiments of the present disclosure. Method 300 can be implemented by, for example, the control unit 204 of FIG. 2 and/or by one or more components in the computing environment of FIG. 1.

At operation 310, resource sharing information comprising resource metadata for a shared resource of a sharer can be stored. The shared resource can be any form of objects, such as web pages, online documents, etc., as described above. The resource sharing information can be initially received from, or set by, the sharer who shares the resource.

The resource metadata can comprise an address of the shared resource and granting information on sharees. The address of the shared resource can indicate an actual position at which the shared resource is stored. In some embodiments, the granting information can comprise a sharee list, and optionally only the sharees in the sharee list can access the shared resource. In some embodiments, in addition to the sharee list, the granting information can further comprise access authorization for each sharee in the sharee list, and optionally each sharee in the sharee list can only access the shared resource with his/her access authorization. The access authorization can comprise viewing, editing, deleting or any combination thereof. For example, sharee A can be set to have the access authorization of viewing for the shared resource, while sharee B can be set to have the access authorization of both viewing and editing for the shared resource. Embodiments of the present disclosure can enable access authorization control over access to the shared resource through the granting information. Optionally, only authorized one or more sharees can access the shared resource with the authorized way of access.

At operation 320, a virtual link can be generated based on the resource metadata. In this operation, a virtual link can be mapped to the resource metadata comprising the storage address of the shared resource. That is, a mapping or a relation between the virtual link and the resource metadata is established. Therefore, when such a virtual link is used by any sharee to access the shared resource, the virtual link can be transferred by the control unit into the storage address, and thus the shared resource can be accessed. With such a mapping, the same virtual link can be used for the sharee to access the shared resource during the whole sharing lifecycle of the shared resource even if the storage address of the shared resource is changed. Further, the virtual link can also carry access authorization included in the resource metadata. There can be two types of virtual links. The first type of virtual link is a common virtual link, which can be shared among a plurality of sharees, while the second type of virtual link is a dedicated virtual link, which can be generated for an individual sharee. Therefore, in some embodiments, a common virtual link can be generated for a group of sharees indicated in the sharee list in the granting information, and the group of sharees will have the same access authorization such as “read” for access to the shared resource through the virtual link. The same access authorization can be a default access authorization or an access authorization indicated in the granting information. Alternatively, a dedicated virtual link can be generated for each sharee indicated in the granting information. As a result, each sharee can have independent access authorization (which can be a default access authorization or an access authorization indicated in the granting information) for the sharee to access the shared resource through the virtual link. The virtual link can be, for example, in the form of a URL or any other suitable form.

At operation 330, the virtual link can be notified (e.g., electronically transmitted via a computer network) to one or more sharees based on the resource metadata. Based on resource metadata, in particular the granting information in the resource metadata, it can be identified which one or more sharees the virtual link is directed to, and thus the virtual link can be notified to the corresponding one or more sharees based on the resource metadata. The virtual link can be transmitted to the one or more sharees by any suitable way such as Email, SMS, etc.

After the one or more sharees receive the virtual link, any sharee among them can access the shared resource through the virtual link, for example, by clicking the virtual link. Correspondingly, a resource request related to the virtual link can be received by the control unit. The control unit can then locate the shared resource based on the mapping between the resource metadata and the virtual link, access the shared resource with the resource metadata, and provide the shared resource to the sharee who tries to access the shared resource through the virtual link. However, there can be situations where the shared resource cannot be accessed successfully due to the fact that the storage address of the shared resource and/or the granting information on the sharee (e.g., the resource metadata) may have been changed. For example, the shared resource may be moved to another address, or the access authorization (for example, from “editing” to “viewing”) for the sharee may be amended if the sharee is removed from a working group. In such situations, since a current resource metadata related with the shared resource is different from resource metadata stored in the control unit, the shared resource may not be accessed successfully by the control unit and thus by the sharee based on the mapping between the resource metadata stored in the control unit and the virtual link. In other words, the resource metadata stored in the control unit is expired in the above situations, such that the shared resource can no longer be successfully accessed using the resource metadata stored in the control unit. Consequently, the sharee's access to the shared resource may be interrupted.

Therefore, at operation 340, the resource metadata stored in the control unit can be updated after the virtual link is notified (e.g., electronically transmitted via a computer network) to the one or more sharees at operation 330. Through the updating, the control unit can successfully locate the shared resource using the updated resource metadata again, i.e., the re-mapping between the virtual link and the updated resource metadata can be established, and thus the sharee can successfully access the shared resource via the same virtual link without having to manually contact the sharer even if the resource metadata has changed. From the perspective of the sharee, the virtual link may appear to be constantly valid until the sharing of the resource is ultimately terminated.

The method 300 according to embodiments of the present disclosure can ensure that the one or more sharees retain access the shared resource seamlessly through the same virtual link during a whole sharing lifecycle of the shared resource without being interrupted.

In some embodiments, the resource metadata can be updated by the control unit periodically. For example, the control unit may periodically retrieve the updated resource metadata from a metadata storage configured in a server hosting the shared resource or in a computer at the sharer side. The resource metadata stored in the metadata storage may be updated in real time by the sharer or the server. For example, the sharer may configure a shared storage for storing real-time resource metadata, and the control unit can retrieve the updated resource metadata from the shared storage periodically. In some embodiments, the resource metadata can be updated by the control unit based on receiving the updated resource metadata from the sharer. The sharer may send the updated resource metadata to the control unit whenever there is an update of the resource metadata. Therefore, the control unit may always obtain the updated resource metadata in real time. For example, a callback interface may be configured in the control unit for the sharer to invoke and push the updated metadata to the control unit.

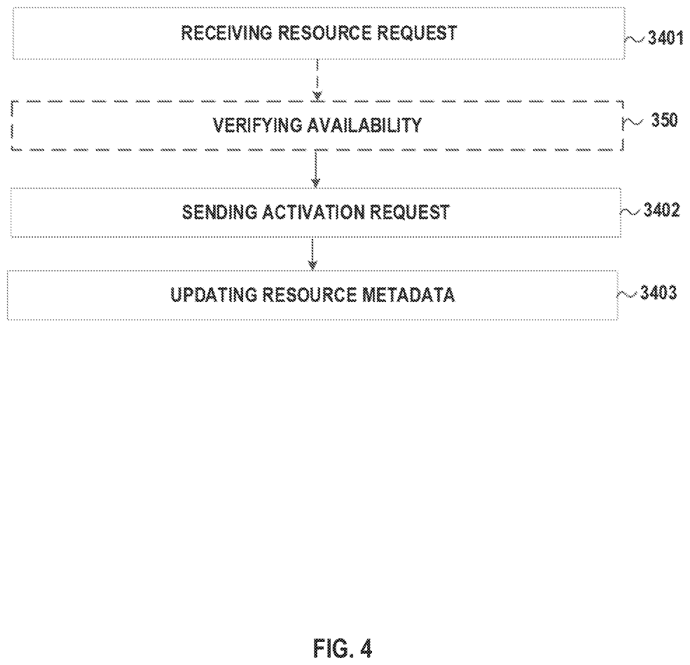

FIG. 4 shows optional sub-operations of operation 340 in the method 300 for updating the stored resource metadata according to some embodiments of the present disclosure, in which the control unit may perform updating actions after receiving a resource request from the one or more sharees. Advantageously, embodiments consistent with FIG. 4 can involve less workload to both the sharer and the control unit.

As shown in FIG. 4, operation 340 can further comprise sub-operations 3401 to 3403. At operation 3401, a resource request for the shared resource related to the virtual link can be received. For example, the request can be generated based on the virtual link being clicked by anyone of the one or more sharees with access to the shared resource.

In order to make the sharee be able to access the resource under the above-mentioned situation that the resource metadata is expired, instead of the sharee having to contact the sharer, at operation 3402, the control unit can communicate with the sharer. In order to facilitate the communication between the control unit and the sharer, in some embodiments, the resource sharing information stored at operation 310 can further comprise communication channel information for the shared resource, and the communication channel information can be used for the control unit to communicate with the sharer through one or more channels. The one or more channels can be in any form of communication tools of the sharer, such as Slack®, Email, phone number, Short Message Service (SMS), WeChat®, Ding Talk® and the like. With such communication channel information, those channels can be registered in the control unit, and the control unit can communicate with the sharer automatically through any of the channels without requiring the sharee to manually contact the sharer. For example, when the re-activating of the shared resource is needed, there is no need for the sharee to contact the sharer manually, instead, the control unit can send a request automatically through any of the registered channels, which can facilitate communication and interaction with the sharer. In some further embodiments, for each of the one or more channels, the communication channel information can further comprise a communication application programming interface (API). The control unit can use the API to initiate communication with the sharer. For example, when communicating with the sharer through a messaging system such as Slack®, the communication API can be a corresponding webhook.

Embodiments of the present disclosure can register communication channel information with the sharer in the control unit such that the control unit can communicate with the sharer through the registered one or more channels and thus the control unit can automatically request the sharer to re-activate the shared resource when accessing to the shared resource based on the resource metadata stored in the control unit failing. Therefore, from the perspective of the sharee, the sharee can always easily and successfully use the same virtual link to access the shared resource without manually contacting the sharer before the sharing is terminated, even if the resource metadata such as the storage address of the shared resource is changed.

Continuing the description of operation 3402. At operation 3402, the activation request can be sent to the sharer for re-activating the shared resource through the one or more channels based on the resource metadata being expired. Upon receiving the resource request at operation 3401, the control unit can determine whether the resource metadata is expired, that is, determine whether the shared resource can be successfully accessed using the stored resource metadata. For example, the control unit can try to access the shared resource using the stored resource metadata and determine whether the access is successful based on feedback from the server hosting the shared resource. Taking the virtual link being a HyperText Transfer Protocol (HTTP) URL as an example, a HTTP 404 status code can indicate that the address of the shared resource is changed, and a HTTP 401 status code can indicate that the granting information is changed. If it is determined that the resource metadata is expired, the control unit can send the activation request at operation 3402 through the one or more channels to the sharer for re-activating the shared resource. Upon receiving the activation request for the re-activating, the sharer can determine whether to approve or deny the request. If the request is approved, the sharer may further perform the re-activating of the shared resource, that is, the sharer can make the shared resource accessible by the control unit. For example, if the access authorization of the sharee configured in the server hosting the shared resource is amended, the sharer may provide the amended access authorization of the sharee used as the updated resource metadata for the control unit to use to update the stored resource metadata. As another example, if the shared resource is moved to a different address, the sharer may provide the different address used as the updated resource metadata for the control unit to use to update the stored resource metadata.

At operation 3403, the resource metadata can be updated based on the re-activating of the shared resource by the sharer. For example, the control unit can update the stored resource metadata with the updated resource metadata received from the sharer. In another example, the callback interface can be configured in the control unit for the sharer to invoke and push the updated resource metadata to the control unit. In yet another example, the sharer may just approve the activation request, and the control unit may retrieve the updated resource metadata from the metadata storage configured in the server hosting the shared resource or in the computer at the sharer side upon receiving the sharer's approval of the activation request. The resource metadata stored in the metadata storage can be updated by the sharer or the server. For example, the sharer can configure the shared storage for storing real-time resource metadata, and the control unit can retrieve the updated resource metadata from the shared storage when needed. Through the updating, the control unit can successfully locate the shared resource using the updated resource metadata again, i.e., the re-mapping between the virtual link and the updated resource metadata is established, and thus the sharee can continue to successfully access the shared resource via the same virtual link without having to manually contact the sharer even if the resource metadata has changed. From the perspective of the sharee, the virtual link can appear to be constantly valid before the sharing of the resource is terminated.

In some embodiments, the sharer may not respond to the activation request immediately, and thus the updating of the resource metadata may not be performed immediately. In this case, it can take some time to recover the sharee's access to the shared resource. The control unit can transmit a notification to the sharee once the updating is done to notify the sharee that he/she can access the shared resource via the same virtual link again.

In some embodiments, in order for the control unit to contact the sharer more efficiently, a predetermined sequence of the one or more channels can be configured. The information on the predetermined sequence of the one or more channels can be included in the communication channel information, which can be initially set by the sharer. The operation 3402 of sending the activation request to the sharer for re-activating the shared resource through the one or more channels can comprise selecting a channel for the sending from the one or more channels according to the predetermined sequence. For example, the sharer can define that his/her predetermined sequence of the channels is in the order of: WeChat®, phone, and Email. Under this configuration, the activation request can be firstly sent to his/her WeChat® account. If the request is not responded after a first predetermined period, the request can be sent through an automated call with his/her phone number. If the request is still not responded after a second predetermined period, the request can be then sent through an Email to his/her Email address. The first predetermined period can be the same or different from the second predetermined period. Furthermore, more or fewer channels in the predetermined sequence of channels (with more or fewer predetermined periods of time) are contemplated in other embodiments.

As mentioned above, in some embodiments, for each of the one or more channels, the communication channel information can comprise a communication API. The request to the sharer can be sent via the communication API for each of the one or more channels, which can facilitate the communication with the sharer. For example, for sending the request to the sharer through a messaging system such as Slack®, the communication API can be the webhook, which can easily launch a real-time transmission of information to the Slack® account.

In some embodiments, in order to achieve effective communication with the sharer, availability of the one or more channels can be verified before the communication, and only the verified channel(s) will be used in the communication with the sharer. As shown in FIG. 3, the verifying of the availability of the one or more channels can occur at operation 350 shown in dotted box before the generating of the virtual link at operation 320, so that it is ensured that the registered one or more channels are usable before generating the virtual link. If any registered channel is not usable, the control unit may request the sharer to correct the information of the channel or register a different channel. Alternatively, as shown in FIG. 4, the verifying of the availability of the one or more channels can occur as operation 350 shown in dotted box before the sending of the activation request to the sharer at operation 3402, so that it is ensured that the channel to be used is usable before sending the activation request. If the channel to be used is not usable, the control unit may use a different registered channel to send the activation request so that the re-activating is not delayed due to using an unusable channel. In some embodiments, the verifying of the availability of the one or more channels may occur both before the generating of the virtual link at operation 320 and before the sending of the activation request to the sharer at operation 3402.

In some embodiments, sharing of the resource may need to be terminated under some circumstances, for example, after an expiration time, or when the target sharee leaves a group. In this regard, a termination policy may be included in the stored resource metadata, and sharing of the shared resource can be terminated according to the termination policy. As shown further in FIG. 3, in order to achieve automatic termination of the sharing of the shared resource for the sharee, method 300 may further comprise an operation 360. At operation 360, the resource sharing information for a sharee among the one or more sharees can be removed based on sharing of the shared resource for the sharee being terminated according to the termination policy, which means the resource metadata and the communication channel information related to the sharee will all be deleted. The virtual link for the sharee can also be revoked at the same time. If sharing of the shared resource for all the sharees indicated in the granting information is terminated according to the termination policy, the whole resource sharing information can be removed, and corresponding one or more virtual links can also be revoked. It should be noted that although operation 360 is shown in FIG. 3 as the last operation of the method 300, it can occur anywhere in the method 300 once the resource sharing information is stored at operation 310. For example, operation 360 can be performed after the resource request is received at operation 3401, or be performed periodically, or be performed based on the resource metadata being expired. In addition, it can be understood that if operation 360 has been performed for the sharee, all the operations 310-350 mentioned above will no longer be performed for that sharee.

The termination policy can indicate one or more conditions under which the sharing of the shared resource needs to be terminated. In some embodiments, the termination policy can comprise the sharing of the shared resource being terminated for the sharee after an expiration date for the sharee, and/or the sharing of the shared resource being terminated for the sharee after access authorization of the shared resource to the sharee is terminated. For example, the expiration date for sharee A may be 20230101 (indicating a date), and the sharing of the shared resource for the sharee A can be terminated on Jan. 1, 2023 accordingly. In another example, sharee B may not be allowed to access the shared resource if he/she quits a current job. In this situation, the access authorization of the shared resource to sharee B can be terminated. For example, the sharer may remove the access authorization of the shared resource when sharee B quits the job and would not update the access authorization even if requested. The control unit can acquire this information when updating the resource metadata.

In the above embodiments related to FIGS. 3-4, an activation request for re-activating the shared resource can be sent to the sharer whenever the resource metadata is expired before the sharing is terminated. In some situations, the sharer may prefer fewer updates. In view of this, a delegation policy can be included in the resource sharing information to indicate whether the re-activating of the shared resource can be performed by the control unit automatically without contacting the sharer. If the delegation policy indicates the re-activating of the shared resource can be performed by the control unit automatically according to the re-activation policy, the delegation policy is full delegation; otherwise, it is non-full delegation.

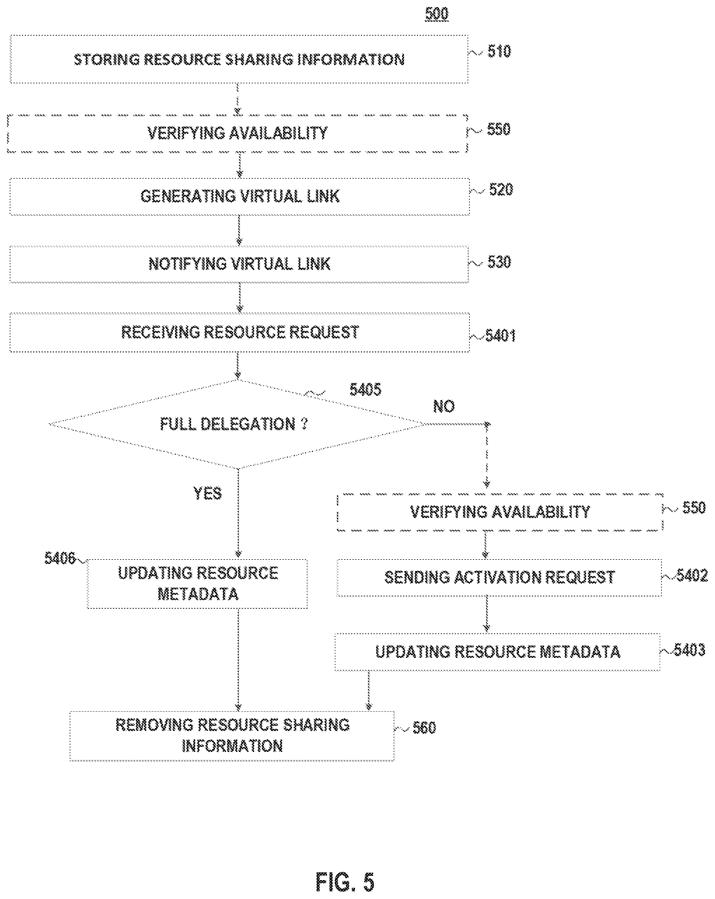

Referring now to FIG. 5, shown is a flowchart of a method 500 for resource sharing according to additional embodiments of the present disclosure. Method 500 can be implemented by the control unit mentioned above with respect to FIG. 2 and/or using one or more components in the computing environment of FIG. 1.

Operations 510, (550), 520, 530, and 560 of FIG. 5 correspond to operations 310, (350), 320, 330, and 360 of FIG. 3 respectively. Furthermore, operations 5401, (550), 5402, 5403 of FIG. 5 correspond to operations 3401, (350), 3402, 3403 of FIG. 4 respectively, and thus the difference between methods 500 and 300 is that method 500 further comprises operations 5405 and 5406.

At operation 5405, the delegation policy included in the resource sharing information can be checked based on the resource metadata being expired. The delegation policy can indicate full delegation or non-full delegation. The full delegation means the control unit can perform the re-activating of the shared resource automatically according to the re-activation policy without contacting the sharer. The non-full delegation means the control unit needs to contact the sharer to re-activate the shared resource. If the delegation policy indicates full delegation, method 500 proceeds to operation 5406, and if the delegation policy indicates non-full delegation, method 500 proceeds to operations 5402 and 5403.

At operation 5406, based on the delegation policy indicating full delegation, the resource metadata can be updated according to the re-activation policy. The re-activation policy can indicate whether or not to update the resource metadata if the resource metadata is expired, and may also be included in the resource sharing information. By updating the resource metadata, the re-mapping between the virtual link and the updated resource metadata can be established, and thus the sharee can continue to access the shared resource via the same virtual link. That is, the shared resource is re-activated. For updating the resource metadata at operation 5406, in some embodiments, the control unit may retrieve the updated resource metadata from the metadata storage configured in the server hosting the shared resource or in the computer at the sharer side. The resource metadata stored in the metadata storage can be updated in real time by the sharer or the server. For example, the sharer can configure the shared storage for storing real-time resource metadata, and the control unit can retrieve the updated resource metadata from the shared storage when needed.

Based on the delegation policy indicating non-full delegation, at operation 5402, similar to operation 3402 of FIG. 4, the activation request can be sent to the sharer for re-activating the shared resource through the one or more channels; and at operation 5403, similar to operation 3403 of FIG. 4, the stored resource metadata can be updated based on the sharer re-activating the shared resource.

Although operation 5405 is illustrated differentiating between full delegation or non-full delegation, in some embodiments operation 5405 can be a multi-operation sub-process whereby partial delegation rules implemented such that some instances require an activation request (e.g., operation 5402) and some instances do not require any activation request (e.g., operation 5406). Such a multi-operation sub-process can determine whether an activation request is needed or whether automatically updating resource metadata is justified based on attributes of the shared resource, sharer, sharee, date, time, location, and/or other attributes.

After the updating at operation 5406 or at 5403, the re-mapping between the virtual link and the resource metadata can be established, and thus the sharee can continue to successfully access the shared resource via the same virtual link without having to manually contact the sharer and change the sharing link. In other words, from the perspective of the sharee, the virtual link appears to be constantly valid before the sharing of the resource is terminated.

In view of the above, embodiments of the present disclosure can enable the sharee to access the shared resource seamlessly during a whole sharing lifecycle of the shared resource without being interrupted by having to contact a sharer. It should be noted that the processing of the computer-implemented method for resource sharing according to embodiments of this disclosure can be implemented in the computing environment of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a computer-implemented method for resource sharing. The method includes storing, by one or more processing units, resource sharing information comprising resource metadata for a shared resource of a sharer; generating, by one or more processing units, a virtual link based on the resource metadata; transmitting, by one or more processing units, the virtual link to one or more sharees based on the resource metadata; and updating, by one or more processing units, the resource metadata.

Example 2 includes the features of Example 1, including or excluding optional features. In this example, updating the resource metadata comprises: updating, by one or more processing units, the resource metadata periodically; or updating, by one or more processing units, the resource metadata based on receiving updated resource metadata from the sharer.

Example 3 includes the features of any one of Examples 1 to 2, including or excluding optional features. In this example, the resource sharing information further comprises communication channel information for the shared resource, and the communication channel information is used for one or more processing units to communicate with the sharer through one or more channels. Optionally, updating the resource metadata comprises: receiving, by one or more processing units, a resource request for the shared resource related with the virtual link; sending, by one or more processing units, an activation request to the sharer for re-activating the shared resource through the one or more channels based on the resource metadata being expired; and updating, by one or more processing units, the resource metadata based on the re-activating of the shared resource by the sharer. Optionally, the communication channel information comprises information on a predetermined sequence of the one or more channels; and sending the activation request to the sharer for re-activating the shared resource through the one or more channels comprises selecting a channel for the sending from the one or more channels according to the predetermined sequence. Optionally, the method further comprises verifying, by one or more processing units, availability of the one or more channels. Optionally, the communication channel information comprises a communication application programming interface (API) for each of the one or more channels.

Example 4 includes the features of any one of Examples 1 to 3, including or excluding optional features. In this example, the resource sharing information further comprises a delegation policy, and updating the resource metadata comprises: receiving, by one or more processing units, a resource request for the shared resource related with the virtual link; and updating, by one or more processing units, the resource metadata according to a re-activation policy based on the delegation policy indicating full delegation and the resource metadata being expired.

Example 5 includes the features of any one of Examples 1 to 4, including or excluding optional features. In this example, the resource metadata comprises a termination policy and the method further comprises: removing, by one or more processing units, the resource sharing information for a sharee among the one or more sharees based on sharing of the shared resource for the sharee being terminated according to the termination policy. Optionally, the termination policy comprises: the sharing of the shared resource being terminated for the sharee after an expiration date for the sharee; or the sharing of the shared resource being terminated for the sharee after access authorization of the shared resource to the sharee is terminated.

Example 6 includes the features of any one of Examples 1 to 5, including or excluding optional features. In this example, the resource metadata comprises an address of the shared resource and granting information on the sharees. Optionally, the granting information comprises a sharee list and access authorization for each sharee in the sharee list.

Example 7 is a system. The system includes one or more processors; a computer-readable storage medium coupled to at least one of the processors; the computer-readable storage medium comprising a set of computer program instructions that when executed by at least one of the processors perform operations according to any one of Examples 1 to 6, including or excluding optional features.

Example 8 is a computer program product. The computer program product includes one or more computer readable storage media having program instructions collectively embodied therewith, the program instructions executable by one or more processors to cause the one or more processors to perform a method according to any one of Examples 1 to 6, including or excluding optional features.

What is claimed is:

1. A computer-implemented method for resource sharing, the method comprising:
storing, by one or more processing units, resource sharing information comprising resource metadata for a shared resource of a sharer;
generating, by one or more processing units, a virtual link based on the resource metadata;
transmitting, by one or more processing units, the virtual link to one or more sharees based on the resource metadata; and
updating, by one or more processing units, the resource metadata.

2. The computer-implemented method of claim 1, wherein updating the resource metadata comprises:
updating, by one or more processing units, the resource metadata periodically; or
updating, by one or more processing units, the resource metadata based on receiving updated resource metadata from the sharer.

3. The computer-implemented method of claim 1, wherein the resource sharing information further comprises communication channel information for the shared resource, and the communication channel information is used for one or more processing units to communicate with the sharer through one or more channels.

4. The computer-implemented method of claim 3, wherein updating the resource metadata comprises:
receiving, by one or more processing units, a resource request for the shared resource related with the virtual link;
sending, by one or more processing units, an activation request to the sharer for re-activating the shared resource through the one or more channels based on the resource metadata being expired; and
updating, by one or more processing units, the resource metadata based on the re-activating of the shared resource by the sharer.

5. The computer-implemented method of claim 4, wherein:
the communication channel information comprises information on a predetermined sequence of the one or more channels; and
sending the activation request to the sharer for re-activating the shared resource through the one or more channels comprises selecting a channel for the sending from the one or more channels according to the predetermined sequence.

6. The computer-implemented method of claim 4, further comprising:
verifying, by one or more processing units, availability of the one or more channels.

7. The computer-implemented method of claim 4, wherein the communication channel information comprises a communication application programming interface (API) for each of the one or more channels.

8. The computer-implemented method of claim 1, wherein the resource sharing information further comprises a delegation policy, and updating the resource metadata comprises:
receiving, by one or more processing units, a resource request for the shared resource related with the virtual link; and
updating, by one or more processing units, the resource metadata according to a re-activation policy based on the delegation policy indicating full delegation and the resource metadata being expired.

9. The computer-implemented method of claim 1, wherein the resource metadata comprises a termination policy and the method further comprises:
removing, by one or more processing units, the resource sharing information for a sharee among the one or more sharees based on sharing of the shared resource for the sharee being terminated according to the termination policy.

10. The computer-implemented method of claim 9, wherein the termination policy comprises:
the sharing of the shared resource being terminated for the sharee after an expiration date for the sharee; or
the sharing of the shared resource being terminated for the sharee after access authorization of the shared resource to the sharee is terminated.

11. The computer-implemented method of claim 1, wherein the resource metadata comprises an address of the shared resource and granting information on the sharees.

12. The computer-implemented method of claim 11, wherein the granting information comprises a sharee list and access authorization for each sharee in the sharee list.

13. A system for resource sharing, comprising:
one or more processors;
a computer-readable storage medium coupled to at least one of the processors;
the computer-readable storage medium comprising a set of computer program instructions that when executed by at least one of the processors perform operations of:
storing resource sharing information comprising resource metadata for a shared resource of a sharer;
generating a virtual link based on the resource metadata;
transmitting the virtual link to one or more sharees based on the resource metadata; and
updating the resource metadata.

14. The system of claim 13, wherein the resource sharing information further comprises communication channel information for the shared resource, and the communication channel information is used to communicate with the sharer through one or more channels.

15. The system of claim 14, wherein updating the resource metadata comprises:
receiving a resource request for the shared resource related with the virtual link;
sending an activation request to the sharer for re-activating the shared resource through the one or more channels based on the resource metadata being expired; and
updating the resource metadata based on the re-activating of the shared resource by the sharer.

16. The system of claim 13, wherein the resource sharing information further comprises a delegation policy, and updating the resource metadata comprises:
receiving a resource request for the shared resource related with the virtual link; and
updating the resource metadata according to a re-activation policy based on the delegation policy indicating full delegation and the resource metadata being expired.

17. The system of claim 13, wherein the resource metadata comprises a termination policy and the set of computer program instructions are configured to perform further operations of:
removing the resource sharing information for a sharee among the one or more sharees based on sharing of the shared resource for the sharee being terminated according to the termination policy.

18. The system of claim 13, wherein the resource metadata comprises an address of the shared resource and granting information on the sharees.

19. The system of claim 18, wherein the granting information comprises a sharee list and access authorization for each sharee in the sharee list.

20. A computer program product for resource sharing, the computer program product comprising one or more computer readable storage media having program instructions collectively embodied therewith, the program instructions executable by one or more processors to cause the one or more processors to:
store resource sharing information comprising resource metadata for a shared resource of a sharer;
generate a virtual link based on the resource metadata;
transmit the virtual link to one or more sharees based on the resource metadata; and
update the resource metadata.
